(19) United States
(12) Patent Application Publication
(10) Pub. No.: US 2024/0360020 A1
(43) Pub. Date: Oct. 31, 2024

(54) HOLISTIC MANURE MANAGEMENT WITH IMPROVED ENVIRONMENTAL SUSTAINABILITY AND EXTRACTION OF MANURE VALUE

(71) Applicant: Sustain Technologies, LLC, Charlotte, NC (US)

(72) Inventors: Robert Hickey, Okemos, MI (US); James Wallace, East Lansing, MI (US); Charles Kontz, Charlotte, NC (US); Michael Hickey, Greenville, SC (US)

(21) Appl. No.: 18/139,511

(22) Filed: Apr. 26, 2023

(51) Int. Cl. C02F 11/04; A01G 33/00; C01B 32/50; C01C 1/02; C02F 3/28

(52) U.S. Cl. CPC C02F 11/04; A01G 33/00; C01B 32/50; C01C 1/024; C02F 3/284; C02F 3/2846; A01K 1/0082; C02F 2001/007; C02F 2103/20; C02F 2303/26

(57) ABSTRACT

Methods and equipment of this invention enable small scale animal farming operations to substantially all or nearly all the recoverable value from their manure streams at a cost suitable for such smaller scale operations. The invention gives small scale animal farming operations the opportunity to obtain manure recovery benefits typically obtainable only in animal farming operations having high animal populations. The recovery is in forms that are both useable, readily monetized, environmentally sustainable, and cost effective. Much of the recovered material can find use back within the processing steps of invention thereby increasing the value of the recovered residual materials.

### FIELD OF THE INVENTION

The present invention relates to methods for treating manure from animal husbandry and livestock operations (hereinafter referred to together as “animal farming”). In further detail this invention involves a method for the processing of manure from animal farming with relatively small livestock populations. More specifically this invention applies to methods and operations that permit the recovery of substantially all the potential value in manure recovered from relatively small animal farming.

### BACKGROUND OF THE INVENTION

Dairy, hog, and poultry manure contains valuable resources including energy content, nitrogen, phosphorous, potassium, sulfur, and water. Most work, to date, in harnessing these valuable resources has focused on using anaerobic digestion to produce biogas that can be used on-site or converted to RNG (renewable natural gas) for injecting into the NG pipeline. In these treatment systems there are residuals that must be managed. In general, management schemes with more than minimal recovery of the available energy and products from manure impose high cost and complex operation currently. There are some approaches being developed to recover more of the value from the manure, but these prove cost effective only for animal farms that have large animal populations and do not recover as much of the potential value as the invention proposed herein.

Suitable treatment systems must be adaptable to wide variations in the composition of the recovered waste. For example, Ruminant manure from a typical ruminant animal house consists of feces, urine, bedding materials, split feed, split drinking water, and water used for washing the pen, typically collected below slatted flooring as slurries. The excretions are separated into solid manure, known as farmyard manure and various semi-solid streams containing manure and other waste materials. The composition of waste from the animal farming of different animals will vary e.g., manure and waste from hog and poultry operations vary considerably as does manure and waste emanating from dairy operations.

A wide variety of equipment in a plurality of configuration have been needed to recover valuable products from animal waste. Treatment of manure from animal farming often starts with removing fibrous solids to produce a liquid stream comprising primarily water and containing suspended solids that include biological material in the form of volatile suspended solids. Removal and conversion of the suspended solids, and the soluble organic compounds, purifies the water and concentrates the remaining solids. The purification removes most of the remaining solids from the liquid to provide recycle water. Most commonly anaerobic digestion (AD) provides the essential breakdown of soluble organics and suspended solids contained in manure with high COD removal efficiencies and low sludge production. In addition to AD, methods and systems integrate one or more of biological treatment, separation, stripping, scrubbing, and contacting into a complete process for treating manure.

Advanced methods and systems are routinely used in the case of treating flush manure (FM) from animal farming of ruminant animals. Any advanced FM manure treatment method requires the basic steps of separating fiber from the FM; treating the resulting FM liquid to breakdown suspended solids; and separating solids from the liquid effluent of the FM treatment. Advanced FM manure treatment methods use a wide variety of equipment and equipment arrangements to carry out these basic steps. In addition to these basic steps most FM treatment method involve additional treatment steps and ancillary equipment to tailor the method to specific characteristics of the recovered FM and the desired outputs.

Initially, raw FM recovered mainly from dairy operations by the flushing of husbandry animal stalls, housing, and areas of confinement, contain a high fiber loading. Such fiber typically comprises undigested and/or partially digested animal feed and in some cases, along with straw, sawdust, or other bedding that becomes mixed with the manure. Removal of fiber is essential to the processing of the remaining FM primarily because of the lignin and lignin-carbohydrate complexes present in grasses which are resistant to breakdown and comprise a large portion of the undigested animal feed along with saw dust that may be present and can interfere with downstream processing. Recovered fiber can also have value in a wide range of other uses such as fuel product, animal bedding, and even construction materials.

Other constituents of animal waste find a wide variety of beneficial uses. Organic carbon in animal waste can provide a major source of renewable energy such as methane gas. The high protein production of ruminant animals also makes their waste rich in organic nitrogen that serves as a source of producing fertilizers and other nitrogenous compounds. Remaining solid residues from the treatment of animal waste can also provide nutrient rich fertilizers, soil adjuvants, and soil amendments. Thus, the most useful systems and methods will enable a high recovery of these outputs and products.

Biogas emanating from manure processing operations contains the methane and other usable chemicals or chemical precursors. Additional biogas components primarily comprise CO2 and sulfur compounds, most prevalently as H2S. The purification of the biogas to useable methane, typically in the form of an RNG stream, requires removal of the CO2 and sulfur compounds. Those skilled in the art know a wide range of methods to treat/remove sulfur compounds and CO2 from gas streams. Such treatments include oxidation of H2S that can also provide a source of sulfuric acid and various adsorbent media that can remove H2S as well as other sulfurous contaminants such as mercaptans. Additional H2S removal methods include feeding biogas to a scrubber that can use a variety of scrubbing/treatment media and methods such as the use of scavenger materials; amine treatment that can remove CO2 and H2S; and aeration systems.

Nitrogen compounds present in the manure or produced by the anaerobic digestion of many organic materials present therein will usually produce ammonia and ammonium compounds. Accordingly, the manure provides a valuable source for extracting high value products ammonium bicarbonate and ammonium carbonate such as ammonium bicarbonate and ammonium carbonate.

Livestock and dairy operation benefit from these systems in other ways, in the production of usable water streams. The production of purified water can provide water for irrigation and the addition of such water can keep a retention lagoon substantially cleaner. With appropriate additional treatments, such water may be used for animal cooling and animal drinking water. The cleansed water can also improve the flushing of the sand lanes, scraped manure removed using water flumes or alley flushes.

Thus, methods for treating manure require the arrangement of many process units and separation steps in a wide array of possible flow arrangements, unit operation and controls. Fine tuning of these process elements and their operation typically adds complexity and cost in both equipment and operation that heretofore made implementation such systems practical for animal farming operations with large populations of animals. As a result, high recovery of manure values remains impractical for small scale animal farming.

What constitutes small scale animal farming may be generally defined by terms of revenue or number animals on a farm or premises. Small scale on a revenue basis generally means a farm or premises with annual sales of less than $500,000. Small scale in terms of animal numbers varies with the type of animal. In the case of ruminants small scale can mean a maximum of 500 small ruminants i.e.—goats/sheep whereas for larger ruminants 100 cows or less would constitute small scale. For non-ruminant animals such as swine (i.e., pigs/hogs) small scale typically means 100 or less animals. For poultry, most typically chickens, small scale meat supply would mean production of 100 animals. For egg production 1,000 birds or less usually means small scale. These numbers generally show the type of operations best suited for this invention.

Animal wastes from small scale operations still contribute to the more than half of the biomass-based wastes generated in the United States and elsewhere. Thus, it is important that such operations process animal waste or manure in an environmentally sustainable manner while remaining cost effective.

U.S. Pat. No. 10,781,143 treats organic waste containing fibrous material by recovering coarse fibers that pass to a biogas digester and mechanically separates the effluent from the biogas digester into a concentrated fraction and a liquid fraction. The liquid fraction after heating to a temperature below the liquid's boiling point enters a flash column to partially removes volatile carbon dioxide. The heated flash liquid passes to an ammonia removal unit that removes ammonia from the liquid. The ammonia free liquid passes through a reverse osmosis unit for the recovery of an ammonia free liquid and a potassium rich fraction useful as a fertilizer concentrate.

U.S. Pat. No. 9,656,895 discloses a process arrangement for treating waste streams containing biodegradable organic substances that feeds the waste stream into an anaerobic bioreactor containing liquid biomass and passing the bioreactor a first effluent flow to a membrane filtration unit in which said feed is subjected to filtration thereby forming a permeate stream and a retentate stream. The retentate stream returns to the bioreactor. A second effluent flow from the bioreactor flow to a sludge treatment unit that produces a third flow stream having an increased organic substance content compared to the second flow, and a fourth flow stream having a decreased organic substance content compared to the second flow stream.

U.S. Pat. No. 9,656,895 feeds the aqueous waste stream of biodegradable material into an anaerobic bioreactor or anaerobic digester (AD) that contains biomass and reacts the biodegradable material with the biomass to form methane. A portion of the bioreactor effluent passes to a membrane filtration unit that produces a retentate for returns to the bioreactor. Another portion of the bioreactor effluent passes to one or more sludge treatment units that provide a treated sludge, a portion of which may pass to the bioreactor along with a flocculation or coagulation additive.

U.S. Pat. No. 10,183,883 pertains to a methane fermentation system which can efficiently generate methane gas wherein an anaerobic microorganism decomposes a waste by methane fermentation to generate methane gas. The methane fermentation system finely pulverizes the organic waste with a wet bead mill.

U.S. Pat. No. 10,144,664 describes a waste stream digester that produces a digestate and passes it through two stages of separation and/or thickening and then returns a remaining fraction of the digestate to the digester.

WO 2005/058764 relates to an anerobic digester (AD) that receives an organic waste liquid in which a concentrator concentrates the digested sludge that then returns to a digester.

U.S. Pat. Nos. 8,486,359 and 8,580,219 disclose methods for recovering ammonium carbonate and ammonium bicarbonate from wastewater associated with the digestion of organic wastes.

U.S. Pat. Nos. 10,793,458, 10,604,432, and 10,106,447 show recovery of ammonium carbonate (AC) and ammonium bicarbonate (AB) by anaerobically digesting agricultural, municipal and/or industrial wastewater and concentrating gaseous ammonia to produce AB and AC from wastewater containing ammonia using gas separation, condensation, and filtration, at controlled operating temperatures.

Dahlan et al, (J Adv Sci Res, 2013, 4(1): 07-12 Journal of Advanced Scientific Research, 2013,) describe the use of AD that retains a flocculent bed and can operate with high or low rates to treat high levels of organic and suspended solids in waste streams.

The preceding description represents only a sampling of the many equipment arrangements and processing methods for treating waste streams including animal waste streams. These references further show extensive range of contacting steps, filtration steps and recovery steps available for manure treatment. While steps described in the references can improve conversion of soluble and suspended solids from manure, the range of additional steps further demonstrates the cost and complexity of using such systems. This again show the complex arrangements that constitute advanced manure systems and have proved practical only for animal farming operations with a relatively large animal population.

Therefore, processes are needed that enable animal farming with a relatively small number of animals to cost effectively and environmentally sustainably recover at least a high amount, and preferably nearly all, of the potential manure value.

### BRIEF SUMMARY OF THE INVENTION

The instant invention provides methods and equipment configurations that enable small scale animal farming operations to recover substantially all or nearly all of the recoverable value from their manure streams at a cost suitable for such smaller scale operations. Thus, this invention gives small scale animal farming operations the opportunity to obtain manure recovery benefits typically obtainable only in animal farming operations having high animal populations.

In addition, the invention provides methods is to recover as much of the value from the manure stream in forms that are both useable and readily monetized. The process scheme and its variations provided by the instant invention are both environmentally sustainable and cost effective. In some embodiments, much of the recovered material can find use back within the processing steps of invention. This can further to helps reduce costs and increasing the value of the recovered residual materials.

The basic method recovers a high percentage of a wide variety of valuable raw materials and products from a feed of dilute manure that contains total suspend solids (TSS) and that comprise coarse fibers and fine suspended solids. The method first separates coarse fibers from the feed to remove at least 25% of the TSS and thereby produce a solids slurry and a filtrate liquid containing suspended solids that comprise fine solids from the manure feed.

The solids slurry pass to a slurry treatment zone that provides thermal and/or catalytic treatment of the slurry to produce solids products, such as biochar or other solids streams with high N & P content, along with a relatively clean liquid and energy containing gases. The filtrate liquid passes to a biological pretreatment having a hydraulic retention time (HRT) of 0.5 to 1.5 days. A CO2 rich gas may be added to the filtrate liquid to promote the precipitation of calcium & magnesium to help reduce any downstream precipitation of Ca and Mg containing compounds.

Filtrate liquid passes filtrate to a biological pretreatment having a hydraulic retention time of 0.5 to 1.5 days. The biological pretreatment hydrolyzes and acidifies the filtrate liquid to produce a biologically pretreated liquid.

Removing TSS from the biologically pretreated liquid produces a concentrated TSS stream and a reduced TSS liquid. The reduced TSS liquid passes to a moderate to high-rate anaerobic reactor having an HRT of 1-4 days to produce an anaerobically treated stream and a first biogas stream of gaseous products and product precursors. The concentrated TSS stream passes to a moderate to high-rate anaerobic digester (AD) to generate a second biogas stream of gaseous products/product precursors and a digestate stream. The AD is typically a CSTR (continuous stirred tank reactor) or plug flow type digester design with an HRT of 20 days or more. At least a portion of a recovered solids stream, comprising solids recovered from the anaerobically treated stream, can be recycled to the CSTR to improve degradation efficiency and the remainder to the slurry treatment zone to increase the recovery of thermal/catalytic products.

Other embodiments may add one or more additional steps or equipment. For example, the separating of the coarse fibers from the feed may provide the solids slurry with at least 25 wt. % of the TSS in the feed. The method may also include a first TSS removal unit that produces the concentrated TSS stream and the reduced TSS liquid from the biologically pretreated liquid and a second TSS unit may separate the anaerobically treated stream emanating from the anaerobic reactor to produce a TSS deficient stream and a recovered solids stream. Another aspect of the invention may pass some or all of the digestate stream to the slurry treatment zone to increase the products available for recovery.

Additional aspects of the invention can add steps to recover a range of products and/or additional quantities of products. In one aspect a portion of the anaerobically treated stream may pass to a nitrogen recovery zone to recover ammonia compounds and a nitrogen deficient stream. Recovered nitrogen from the anaerobically treated stream may go directly to saleable ammonium hydroxide or ammonium bicarbonate.

The nitrogen deficient stream has a wide variety of uses. The nitrogen deficient stream may find use in enhancing the production of aquatic plans such as duckweed or to vermiculture. The nitrogen deficient stream also provides a source of treatable water.

In another aspect the feed will contain sulfur compounds that can be recovered from the biogas streams and the slurry treatment zone may produce thermal or catalytic products.

In another aspect the hydrolysis and acidification of the biological pretreatment zone will increase the generation of biogas, by producing additional Scod.

Another aspect may include passing at least a portion of the first biogas stream and/or the second biogas stream to a biogas upgrade section that includes a biogas upgrade zone and that provides additional treatment biogas upgrading steps to produce RNG, to recover sulfur rich biochar/biocarbon, and/or to remove H2S.

The following FIGURES and description disclose equipment and arrangements for practicing the method of this invention from which further embodiments will be apparent.

### BRIEF DESCRIPTION OF THE DRAWINGS

FIG. 1 is a process flow diagram showing the basic arrangement and equipment of the invention along with other variations in the arrangement of the equipment and stream destination for practicing the various embodiments and aspects of the invention.

### DETAILED DESCRIPTION OF THE INVENTION

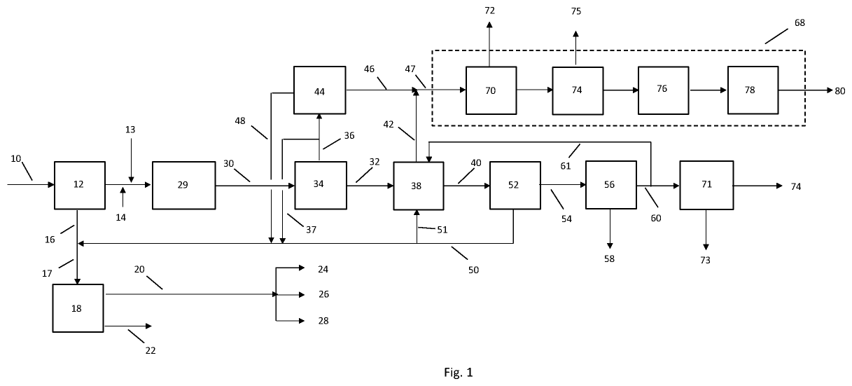

The process flow scheme depicted in FIG. 1, shows steps/equipment in a robust operation of the invention that utilizes steps, equipment, and arrangements in addition to those of the basic embodiment of the invention as described above. Particular applications of the invention to specific sites or situations may utilize additional step/equipment as appropriate to obtain additional recovery of value from the processing of manure.

In one aspect, the separation of TSS may include use of screens, screw presses, rotating drums, or similar equipment to remove the coarse fibers from the manure feed. These devices will remove at least at least 25 wt. % of the TSS in the feed by producing a filtrate liquid that contains a lower concentration of TSS. The retained solids are present as a solids slurry that may contain at least 25 wt. % of the feed solids and in other embodiments may contain 30% to 40% or more of the total suspended solids present in the feed. The remainder of the feed comprises a filtrate liquid.

The method treats the filtrate liquid in a biological pretreatment step having a short HRT of 0.5 to 1.5 days. This biological pretreatment is designed to hydrolyze TSS (fine solids) that remain in the filtrate liquid. The biological pretreatment will typically produce additional sCOD, especially volatile fatty acids (VFA), to help maximize the amount of methane generated downstream in the AD and/or in the anaerobic reactor. A grinder pump or similar techniques can reduce size of particles in the biological pretreatment step and potentially increase the surface area and availability of the fine solids to biological degradation and thereby improve the performance of the downstream AD systems.

Biogas produced in the biological pretreatment step can be combined with the biogas from the downstream anaerobic reactor or biogas from the AD may be directly blended with the biogas stream from that anaerobic reactor and treated in a combined biogas treatment step.

Following the short HRT biological pretreatment step, a TSS removal step captures most of the remaining TSS in a concentrated TSS stream and leaves a reduced TSS liquid. This operation typically employs a centrifuge, fine screen, or other process alternatives that provide high TSS removal efficiencies. It is important to remove most of the TSS so that the anaerobic reactor processes a reduced TSS liquid and can operate with a moderate retention time of 1-4 days to provide an anaerobically treated stream. The HRT of the anaerobic reactor is much lower than the more conventional 20 to 30 day HRT in CSTRs and plug flow processes.

Following TSS removal the moderate rate anaerobic reactor treats the VFA rich, low TSS stream produced in the biological pretreatment step in the moderate rate anaerobic reactor to generate biogas comprising methane that is ultimately converted to RNG or directly used on-site. The anaerobic reactor may be any number of variants of an anaerobic contact process, an anaerobic filter, or similar moderate organic loading rate system that operates at relatively short HRT on the order of 1 to 4 days compared to the more conventional HRT of 20 to 30 days typical of continuous stirred tank reactors and plug flow processes. In some cases, the TSS are of low enough in concentration that higher rate processes such as high-rate granular sludge systems (e.g., ICX—Internal Circulation Experience, ECSB—External Circulation Sludge Bed, EGSB—expanded granular sludge bed) can be used to shrink the required HRT even more. Other anaerobic reactors for possible use include an upflow anaerobic contact reactor, an upflow anaerobic sludge blanket reactor, a hybrid of upflow anaerobic contact reactor and an upflow anaerobic sludge blanket reactor, or an anaerobic baffled reactor.

The AD receives the concentrated TSS stream. The AD is adapted to process the concentrated TSS stream and typically comprises a High Solids CSTR system. The AD may receive all the concentrated stream. Alternately the concentrated stream may be blended in whole or in part with the coarse fibers and sent on to slurry treatment to produce thermal products as previously described.

Another TSS removal unit will typically remove most if not all the remaining TSS from the anaerobically treated stream to provide a TSS deficient stream and a stream of recovered solids. Recovered solids separated from the anaerobic reactor effluent along with recovered solids from the AD may be passed to the slurry treatment zone and/or returned to the AD. Coarse fibers may be blended with any TSS passing to the slurry treatment zone.

Biogas produced by the anaerobic digester and/or the anaerobic reactor is typically cleaned and compressed to produce RNG and a CO2 rich tail gas stream that also contains some methane, H2S and N2.

The anaerobic reactor effluent stream can be further treated to remove the remaining TSS and/or directly processed to recover ammonia as a product stream using any number of stripping or steam stripping options. Possible products include NH4OH, NH4HCO3, and an ammonium organic acid stream such as ammonium lactate or ammonium citrate. Gas produced by the slurry treatment can also be used for stripping ammonia from the TSS deficient stream.

Alternately all or a portion of the reactor effluent may serve as a source of nutrients to grow valuable by-products that include but are not limited to aquatic plants including duckweed and algae, vermicompost or land-based crops. The objective of these unit operations is to recovery as much of the nutrients as can be economically captured and not necessarily achieve an extremely high removal efficiency.

After nutrient recovery the anaerobically treated stream can receive further treatment to produce a relatively clean water for use as water for manure flushing, crop irrigation water, for cow cooling and cow drinking water. The level of treatment required is dictated by the desired end use(s). For example, when used for irrigation, no additional water treatment is likely required because the TSS concentration is relatively low, and the particle size is small. Typical irrigation systems such as center pivot can readily use such water for crop irrigation. Other uses such as producing water for cow cooling may require a reduction in the levels of COD/BOD, nitrogen, phosphorous and TSS followed by disinfection.

The coarse fibers removed from the feed undergo thermal, hydrothermal or catalytic processing in the slurry treatment zone to produce valuable products. Products may include biochar, bio-carbon, and valuable side streams such as syngas, steam/hot water, clean water condensates and in some cases a nutrient and ion rich water stream. The recovered biochar or bio-carbon material is stable, suitable for storage as needed, saleable as a valuable soil amendment, or even used back in the overall biogas cleanup process to capture sulfur.

Any produced syngas or biogas recovered from the slurry treatment can be used to make additional RNG, to generate power, and/or to generate heat or steam for use in the overall process. It is also possible to perform a water gas shift reaction the syngas to convert the CO to H2. This H2 rich gas, which also has CH₄ and CO2, can be fed to one of the anaerobic treatment systems where H2 and CO2 are converted to CH4 resulting in more biogas available to convert to RNG.

In additional aspects the solids captured after the biological pretreatment step and/or from the anaerobic reactor effluent can serve as a source of additional products. These solids can be blended with the coarse fibers and co-processed in the thermal processing step as described above thereby increasing the mass of the valuable products produced. Separate thermal processing of these solids can produce a suite of products that results in the highest value from the solids captured from the manure. In some instances, simply drying these solids using waste heat and pelletizing the solids for sale may result in an overall maximum economic benefit.

### DETAILED DESCRIPTION OF THE FIGURE

The FIGURE shows various embodiment of the invention.

In basic embodiment coarse fibers are separated from feed 10 in a coarse fiber removal zone 12 to provide solids slurry 16. Slurry 16 passes to a line 17 and then to a slurry treatment zone 18 that thermally or catalytically treats the slurry solids. Slurry treatment zone 18 delivers one or more thermal products via streams 20 and 22. A line 50 may pass recovered solids to slurry treatment zone 18 via line 17. Stream 20 provides one or more outputs comprising biochar 24, biochar to be used for H2S removal from the biogas 26, and nutrient rich aqueous streams 28. Line 22 withdraws gas produced by the slurry treatment zone that can provide internal heat for process operations such as steam stripping of ammonia recovered by the process. The gas from line 22 may also get converted to RNG.

A line 14 recovers a filtrate liquid from zone 12 that in a broad treatment embodiment passes to biological treatment. CO2 from the biogas upgrade process can be added via line 13 to help reduce the dissolved concentrations of Ca and Mg by precipitating a portion of these elements as Ca or Mg carbonate compounds. The biological treatment that produces a biologically pretreated liquid that ultimately provides a concentrated TSS stream and a reduced TSS stream. In this broad treatment embodiment, a reduced TSS stream 32 passes to a moderate-rate AR 38 and a concentrated TSS stream 36 passes to a conventional CSTR AD 44.

The FIGURE shows a particular embodiment of the biological pretreatment wherein a line 30 recovers a biologically treated effluent from a distinct biological treatment zone 29 and passes effluent 32 to a separate and distinct TSS removal zone 34. TSS removal zone 34 separates the biologically treated effluent into the concentrated TSS stream 36 and the reduced TSS stream 32. Reduced TSS stream 32 passes to a moderate-rate AR 38 and the concentrated TSS stream 36 passes to conventional CSTR AD 38.

In an alternate embodiment the biological pretreatment zone provides pretreatment and incorporates settling operation that also separates the reduced TSS stream and the concentrated TSS stream within a single unit. Thus, in this embodiment the biological pretreatment zone treats the filtrate liquid and separates of the biologically treated liquid to provide both the reduced TSS stream 32 and the concentrated TSS stream 36.

Moderate-rate AD 38 produces an anaerobically treated stream 40 and first biogas stream 42. A recovered solids stream 50 may pass additional solids to anaerobic reactor 38 via line 51. A portion of a recovered solids stream 50 may pass to anaerobic reactor 38 via line 51 and/or line 50 may pass additional solids to slurry treatment zone 18.

Moderate to high-rate AD 44 generates a second biogas stream 46 and a digestate stream 48. A line 37 may take a portion of the concentrated solids stream and pass it to line 50 to provide additional solids to slurry treatment zone 18

The FIGURE shows additional treatment steps and flow arrangements that provide additional embodiments of the invention.

An expanded embodiment also includes: a second TSS removal unit 52 that separates anaerobically treated stream 40 into TSS deficient stream 54 and provides recovered solids stream 50; and passing TSS deficient stream 54 to nitrogen recovery zone 56 that produces ammonia recovery stream 58 and nitrogen deficient stream 60.

In various embodiments nitrogen deficient stream 60 can find a wide variety of uses. One such use is as a water source. In such use stream 60 enters a treatment zone 71. Treatment zone 71 is adapted to provide necessary treatments to provide flush water to a storage lagoon; disinfection for uses such as cow cooling; and/or additional tertiary treatment to supply cow drinking water. Treatment zone 71 may also be used for the production of algae and/or aquatic plants such as duckweed and/or use in vermiculture which are shown as product stream 73. The cleaned water stream from treatment zone 71 is shown as line 74.

A further expanded embodiment of the invention, that includes all the steps described in the above embodiments, passes first biogas stream 42 and second biogas stream 46 to biogas upgrade section 68 via line 47 wherein the biogas passes to an upgrade zone 70. Upgrade zone 70 can provide numerous ways to process the biogas to RNG shown as line 72.

In one embodiment for processing the tail gas from biogas upgrade 70, at least a portion is processed in biochar scrubber 74, for some H2S removal and increasing the sulfur content of the biochar produced in slurry treatment zone 18. Final polishing/removal of the H2S after biochar scrubber 74 is accomplished in biogas scrubbing step 76, and CO2 recovery in step 78 resulting in high purity CO2 shown as 80. The CO2 rich gas from line 80 may undergo clean-up for sale and industrial or other uses, sent to disposal, or used back in the process to help precipitate Ca and Mg compounds shown as line 13.

In another embodiment a line 61 passes a portion of nitrogen deficient stream 60 to anaerobic reactor 38 to help reduce the ammonia concentration therein and eliminate any potential ammonia inhibition of the anaerobic process.

As described, the present invention provides numerous advantages, some of which have been described above and others which are inherent in the invention. Also, modifications may be proposed without departing from the teachings herein. Accordingly, the scope of the invention is only to be limited as necessitated by the accompanying claims.

We claim:

1. A method for recovering a high percentage of a wide variety of valuable raw materials and products from a feed (10) of dilute manure (10) containing total suspend solids (TSS) comprising coarse fibers and fine suspended solids, the method comprising:
a. separating coarse fibers from the feed (10) to remove at least 25% of the TSS and thereby produce a solids slurry (16) and a filtrate liquid (14) containing suspended solids that comprises fine solids from the feed (10);
b. passing the solids slurry (16) to a slurry treatment zone (18) that provides thermal and/or catalytic treatment of the slurry solids to produce thermal products comprising biochar (24), nutrient rich aqueous streams (28) and/or energy containing gases such as syngas;
c. passing filtrate liquid (14) to a biological pretreatment (29) having a hydraulic retention time of 0.5 to 1.5 days, wherein at least a portion of the fine solids are hydrolyzed and acidified to produce a biologically pretreated liquid (30);
d. removing TSS from the biologically pretreated liquid (30) to produce a concentrated TSS stream (36) and a reduced TSS liquid (32);
e. passing the reduced TSS liquid (32) to a moderate to high-rate anaerobic reactor (38) having a hydraulic retention time of 1-4 days to produce an anaerobically treated stream (40) and a first biogas stream (42) comprising gaseous products and/or product precursors;
f. passing the concentrated TSS stream (36) to an anaerobic digester (44) to generate a second biogas stream (46) of gaseous products and/or product precursors and to generate a digestate stream (48), the anaerobic digester (44) being a CSTR or plug flow type digester design with an SRT of 20 days or more; and,
g. passing at least a portion of a recovered solids stream (50), comprising solids recovered from the anaerobically treated stream (40), to the anaerobic reactor (38) and/or to the slurry treatment zone (18) to increase the recovery of thermal products and the availability of other products.

2. The method of claim 1 wherein at least of the 25 wt % of TSS in the feed (10) are concentrated into the solids slurry (16).

3. The method of claim 1 wherein the biological pretreatment (29) includes a biological pretreatment zone that produces the biologically pretreated liquid (30) and the biologically pretreated liquid (30) passes to a first TSS removal unit (34) that supplies the concentrated TSS stream (36) and the reduced TSS liquid (32).

4. The method of claim 1 wherein the filtrate liquid (14) is processed to reduce the size of particles therein before it enters the biological pretreatment (29).

5. The method of claim 1 wherein the anaerobically treated stream (40) passes to a second TSS removal unit (52) that produces a TSS deficient stream (54) containing recoverable nitrogenous products along with recoverable water and provides the recovered solids stream (50).

6. The method of claim 1 wherein the gas produced by the slurry treatment zone (18) is used for at least one of providing internal heat for the practice of the method, stripping ammonia from the TSS deficient stream (54), or conversion into RNG.

7. The method of claim 1 wherein at least a portion of the digestate stream (48) is passed to the slurry treatment zone (18) to increase the production of thermal products.

8. The method of claim 1 wherein the anaerobic reactor (38) operates as an upflow anaerobic contact reactor, an upflow anaerobic sludge blanket reactor, a hybrid of upflow anaerobic contact reactor or an upflow anaerobic sludge blanket reactor, or an anaerobic baffled reactor.

9. The method of claim 5 wherein at least a portion of the recovered solids stream (50) passes to the anaerobic digester (44).

10. The method of claim 1 wherein the first biogas stream (42) and/or the second biogas stream (46) pass to a biogas upgrade section (68) including a biogas upgrade zone (70) that provides additional treatment steps for biogas upgrading to produce RNG, a biochar scrubber (74) to recover sulfur rich biochar/biocarbon, an H2S removal zone (76) for removing H2S, and/or a CO2 recovery zone (78) for providing a CO2 rich gas.

11. The method of claim 10 wherein biochar is recovered from the slurry treatment zone (18) and passes to biochar scrubber (74) for use in the production of sulfur rich biochar/biocarbon.

12. The method of claim 10 wherein the biogas upgrade section (68) includes a biogas upgrade zone (70) that produces a gas stream suitable for RNG use or conversion to chemicals.

13. The method of claim 1 wherein at least a portion of the anaerobically treated stream (40) passes to a nitrogen recovery zone (56) to recover ammonia compounds and a nitrogen deficient stream (60).

14. The method of claim 1 wherein at least a portion of the anaerobically treated stream (40) is used for at least one of providing treated water, producing aquatic plants, producing algae, or supporting vermiculture.

15. The method of claim 10 wherein a CO2 rich gas stream (80) is recovered from the biogas upgrade section (68) and treated for industrial use.

16. The method of claim 13 wherein a water stream is recovered from the nitrogen deficient stream (60) and is further treated to produce a treated stream usable as flush water and/or suitable for appropriate treatment to use for cow cooling and/or for cow drinking water.

17. The method of claim 14 wherein at least a portion of the nitrogen deficient stream (60) is used to produce aquatic plants and the aquatic plants are harvested and supply substrate for biogas production and/or a feed supplement.

18. The method of claim 1 wherein TSS removal from the biologically pretreated liquid (30) includes an integrated settling operation that produces the reduced TSS liquid (32) and the concentrated TSS stream (36).

19. A method for recovering a high percentage of a wide variety of valuable raw materials and products from a feed (10) of dilute manure containing total suspend solids (TSS) comprising coarse fibers and fine suspended solids, the method comprising:
a. separating coarse fibers from the feed (10) to remove at least 25% of the TSS and thereby produce a solids slurry (16) containing at least 25 wt % of the TSS in the feed (10) and a filtrate liquid (14) containing remaining suspended solids that comprises fine solids from the feed (10);
b. passing the solids slurry (16) to a slurry treatment zone (18) that provides thermal and/or catalytic treatment of the slurry solids to produce thermal products comprising biochar (24), nutrient rich aqueous streams (28) and/or gases (22, 26) containing recoverable energy;
c. passing filtrate liquid (14) to a biological pretreatment (29) having a hydraulic retention time of 0.5 to 1.5 days, wherein at least a portion of the fine solids are hydrolyzed and acidified to produce a biologically pretreated liquid (30);
d. removing TSS from the biologically pretreated liquid (30) in a first TSS removal unit (34) to produce a concentrated TSS stream (36) and a reduced TSS liquid (32);
e. passing the reduced TSS liquid (32) to a moderate to high rate anerobic reactor (38) having a hydraulic retention time of 1-4 days to produce an anaerobically treated stream (40) and a first biogas stream (42) comprising gaseous products and/or product precursors;
f. passing the anaerobically treated stream (40) to a second TSS removal unit (52) to produce a TSS deficient stream (54) and a recovered solids stream (50);
g. passing the concentrated TSS stream (36) to an anaerobic digester (44) to generate a second biogas stream (46) of gaseous products and/or product precursors and to generate a digestate stream (48), the anaerobic digester (44) being a CSTR or plug flow type digester design with an SRT of 20 days or more;
h. passing at least a portion of the recovered solids stream (50), to the anaerobic reactor (38) and/or the slurry treatment zone (18) to increase the availability of products for recovery;
i. passing at least a portion of the digestate stream (48) to the slurry treatment zone (18) to increase the products available for recovery and,
j. passing at least a portion of the TSS deficient stream (54) to a nitrogen recovery zone (56) to recover ammonia compounds and a nitrogen deficient stream (60).

20. A method for recovering a high percentage of a wide variety of valuable raw materials and products from a feed (10) of dilute manure containing total suspend solids (TSS) comprising coarse fibers and fine suspended solids and containing sulfur compounds, the method comprising:
a. separating coarse fibers from the feed (10) to remove at least 25% of the TSS and thereby produce a solids slurry (16) containing at least 25 wt % of the TSS in the feed (10) and a filtrate liquid (14) containing remaining suspended solids that comprises fine solids from the feed (10);
b. passing the solids slurry to a thermal/catalytic treatment zone (18) to produce thermal and/or catalytic products/biochar (24), nutrient rich aqueous streams (28) and/or gases (22, 26) containing recoverable energy;
c. passing filtrate liquid (14) to a biological pretreatment (29) having a hydraulic retention time of 0.5 to 1.5 days, wherein at least a portion of the fine solids are hydrolyzed and acidified to increase the recovery of biogas, to produce sCOD, and to metabolize sulfur compounds to H2S thereby producing a biologically pretreated liquid (30) containing sCOD and H2S;
d. removing TSS and sCOD, from the biologically pretreated liquid (30) in a first TSS removal unit (34) to produce a concentrated TSS stream (36) containing H2S, sCOD, and to produce a reduced TSS liquid (32);
e. passing the reduced TSS liquid (32) to a moderate to high rate anerobic reactor (38) having a hydraulic retention time of 1-4 days to produce an anaerobically treated stream (40) and a first biogas stream (42);
f. passing the anaerobically treated stream (40) to a second TSS removal unit (52) to produce a TSS deficient stream (54) and a recovered solids stream (50);
g. passing the concentrated TSS stream (36) to an anaerobic digester (44) to generate a second biogas stream (46) of gaseous products and/or product precursors and to generate a digestate stream (48), the anaerobic digester (44) being a CSTR or plug flow type digester design with an SRT of 20 days or more;
h. passing at least a portion of a recovered solids stream (50), comprising solids recovered from the anaerobically treated stream (40), to the anaerobic digester (44) and/or the thermal treatment zone (18) to increase the availability of products for recovery;
i. passing at least a portion of the digestate stream (48) to the slurry treatment zone (18) to increase the products available for recovery;
j. passing at least a portion of the anaerobically treated stream (40) to a nitrogen recovery zone (56) to recover ammonia compounds (58) and a nitrogen deficient stream (60); and,
k. passing at least a portion of the first biogas stream (42) and/or the second biogas stream (46) to a biogas upgrade section (68) including a biogas upgrade zone (70) that provides additional treatment steps for biogas upgrading to produce RNG, a biochar scrubber (74) to recover sulfur rich biochar/biocarbon, an H2S removal zone (76) for removing H2S, and/or a CO2 recovery zone (78) for providing a CO2 rich gas; and,
l. recovering one of more of treatable water, duckweed, vermicompost and treatable water from the nitrogen deficient stream.
